(19) United States
(12) Patent Application Publication
(10) Pub. No.: US 2017/0161616 A1
(43) Pub. Date: Jun. 8, 2017

(54) ATHLETIC FEEDBACK MECHANISM

(71) Applicant: Intel Corporation, Santa Clara, CA (US)

(72) Inventors: Mei Lu, Portland, OR (US); Nicholas Moe Khosravy, Palo Alto, CA (US)

(73) Assignee: Intell Corporation, Santa Clara, CA (US)

(21) Appl. No.: 14/960,882

(22) Filed: Dec. 7, 2015

(51) Int. Cl. G06N 5/04; G06F 1/16; A63B 24/00; G06N 99/00

(52) U.S. Cl. CPC G06N 5/04; G06N 99/005; G06F 1/163; A63B 24/0021; A63B 2024/0025

(57) ABSTRACT

A method is described to facilitate athletic feedback. The method includes identifying a route that is to be taken during a user workout, performing predictive analysis of the route and providing real-time feedback to a user based on the predictive analysis.

### FIELD

Embodiments described herein generally relate to wearable computing. More particularly, embodiments relate to sports training based wearable devices.

### BACKGROUND

Endurance athletes (e.g., cyclists, runners, skiers, triathletes, hiking, etc.) often train or race on roads that have significant elevation changes. Particularly, a cyclist's consideration for training intensity, effort, performance, and accomplishment often centers around elevation gain or total vertical distance on a road. Thus, a cyclist pays close attention to terrain information in order to select an appropriate route for training. A workout is often designed to train a cyclist's ability to quickly climb steep slopes with a large gradient change, or to the top of a mountain. Moreover, a workout may feature cyclists virtually racing one another on a social network site to find out which cyclist can quickly reach the top of the mountain (e.g., become “king of the mountain”). Cyclists may also measure accomplishments by how much elevation gain achieved in a day, week or year. While riding through a road with a large elevation gain, a cyclist may typically be in a “painful” situation in the sense that they have to exert and sustain strenuous effort.

Current fitness or training applications utilize minimum terrain information to provide real time training feedback. Some applications may provide an update on total elevation gain, for example, at every mile of a workout. Further, social information may be utilized for virtual racing or motivation purposes. However, none of the existing applications incorporate predictive information on the type of terrain an athlete will experience ahead, or combine social and predictive terrain information to provide real time recognition of performance or accomplishment.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates an athletic feedback mechanism at a computing device according to one embodiment.

FIG. 2 illustrates one embodiment of an athletic feedback mechanism.

FIG. 3 is a flow diagram illustrating one embodiment of a process performed by an athletic feedback mechanism.

FIG. 4 illustrates a computer system suitable for implementing embodiments of the present disclosure.

### DETAILED DESCRIPTION

Embodiments may be embodied in systems, apparatuses, and methods for athletic feedback, as described below. In the description, numerous specific details, such as component and system configurations, may be set forth in order to provide a more thorough understanding of the present invention. In other instances, well-known structures, circuits, and the like have not been shown in detail, to avoid unnecessarily obscuring the present invention.

Embodiments provide for an athletic feedback mechanism to integrate terrain knowledge and social information to provide appropriate training feedback, encouragement and acknowledgement to an endurance athlete, such as a cyclist, skier, triathlete, hiking, etc. In such an embodiment, terrain and social information are utilized to provide context-appropriate real time feedback or responses to an athlete in order to make training more encouraging, satisfying and informative. For example, based on the route a cyclist is taking and information regarding the surrounding terrain, athletic feedback mechanism can predict that a cyclist is almost reaching the top of a mountain, and provide strong encouragement to race through a difficult segment prior to reaching the top.

In one embodiment, the athletic feedback mechanism provides three types of feedback or responses related to terrain and social information. These include encouragement when an athlete is exerting substantial effort (e.g., a cyclist riding over a slope); acknowledgement or recognition for accomplishment; and responses to user queries (e.g., on terrain information). According to one embodiment, the feedback or responses are based on both knowledge on what an athlete has completed for a workout and prediction of what will be experienced ahead.

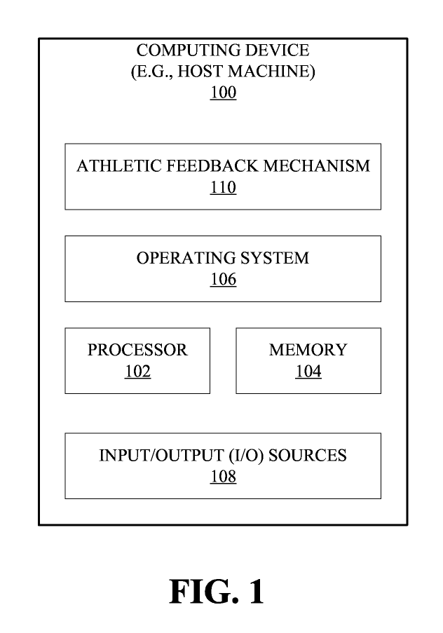

FIG. 1 illustrates one embodiment of an athletic feedback mechanism 110 at a computing device 100. In one embodiment, computing device 100 serves as a host machine for hosting athletic feedback mechanism (“feedback mechanism”) 110 that includes a combination of any number and type of components for athletic feedback at computing devices, such as computing device 100. In one embodiment, computing device 100 includes a wearable device. Thus, implementation of feedback mechanism 110 results in computing device 100 being an assistive device to provide effective audio feedback to a wearer of computing device 100.

In other embodiments, athletic feedback operations may be performed at a computing device 100 including large computing systems, such as mobile computing devices, such as cellular phones including smartphones, personal digital assistants (PDAs), tablet computers, laptop computers (e.g., notebook, netbook, Ultrabook™, etc.), e-readers, etc. In yet other embodiments, computing device 100 may include server computers, desktop computers, etc., and may further include set-top boxes (e.g., Internet-based cable television set-top boxes, etc.), global positioning system (GPS)-based devices, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

Throughout this document, terms like “logic”, “component”, “module”, “framework”, “engine”, “point”, and the like, may be referenced interchangeably and include, by way of example, software, hardware, and/or any combination of software and hardware, such as firmware. Further, any use of a particular brand, word, term, phrase, name, and/or acronym, such as “avatar”, “avatar scale factor”, “scaling”, “animation”, “human face”, “facial feature points”, “zooming-in”, “zooming-out”, etc., should not be read to limit embodiments to software or devices that carry that label in products or in literature external to this document.

It is contemplated that any number and type of components may be added to and/or removed from athlete feedback mechanism 110 to facilitate various embodiments including adding, removing, and/or enhancing certain features. For brevity, clarity, and ease of understanding of athlete feedback mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

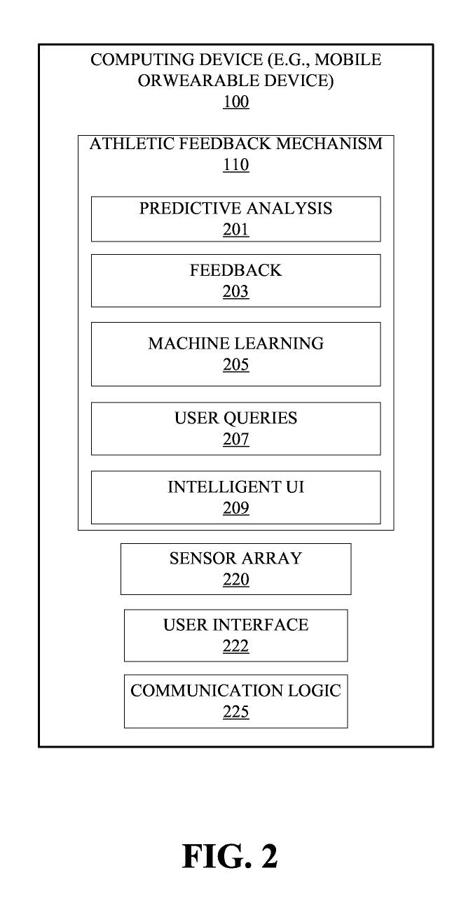

FIG. 2 illustrates an athletic feedback mechanism 110 employed at computing device 100. In one embodiment, athletic feedback mechanism 110 may include any number and type of components, such as: predictive analysis module 201, feedback module 203, machine learning logic 205, user queries module 207, and intelligent user interface (UI) module 209. It is contemplated that any number and type of components 201-207 of feedback mechanism 110 may not necessarily be at a single computing device and may be allocated among or distributed between any number and type of computing devices having (but are not limited to) server computing devices, cameras, PDAs, mobile phones (e.g., smartphones, tablet computers, etc.), personal computing devices (e.g., desktop devices, laptop computers, etc.), smart televisions, servers, wearable devices, media players, any smart computing devices, and so forth. Further examples include microprocessors, graphics processors or engines, microcontrollers, application specific integrated circuits (ASICs), and so forth. Embodiments, however, are not limited to these examples.

According to one embodiment, predictive analysis module 201 provides analysis on a type of route an endurance athlete (or user) will be taking during a workout. In such an embodiment, predictive analysis module 201 implements an algorithm to identify and predict the route. In one embodiment, predictive analysis module 201 predicts a route based on a current route the athlete is travelling, previously taken routes the athlete has taken, social information on routes other athletes have taken and nearby terrain information. In such an embodiment, predictive analysis module 201 uses positioning sensors (e.g., GPS) included in sensor array 220.

In a further embodiment, predictive analysis module 201 provides an analysis on a terrain situation ahead of the athlete to identify major milestones along the predicted route, as well as an effort needed to reach the milestones (e.g., vertical or route distances to the top of the slope, vertical or route distances to the top of the mountain, number of slopes to reach the top of the mountain, and estimated time to reach these milestones). In yet a further embodiment, predictive analysis module 201 identifies key points on the route at which an athlete may need encouragement or acknowledgement, such as when the athlete is closer to, or has reached the top of the mountain.

Feedback module 203 provides real-time feedback regarding encouragement, acknowledgement or recognition of accomplishments. For example, feedback module 203 may encourage an athlete half-way through, or at the last mile until the top of, a slope. Further, feedback module 203 may provide a strong recognition when the athlete reaches the top of the mountain. In one embodiment, feedback module 203 provides audio feedback via a user interface 222, which provides for user interaction with computing device 100.

Machine learning logic 205 is implemented to receive feedback data and automatically adapt to the creation of encouragement and acknowledgement data as feedback mechanism 110 learns information about the user's workout habits. In one embodiment, unsupervised learning reinforces positive outcomes with raw data. In such an embodiment, machine learning logic 205 uses deep learning to accelerate both the development of new achievements and encouragement, and reduces a need for more manual/semi-supervised feature creation.

User queries module 207 is implemented to receive user queries on current and predictive terrain information during training. In one embodiment, intelligent UI module 209 conducts queries on a user's behalf to enable feedback module 203 to provide useful feedback even if the user has not queried for information. In a further embodiment, user interface 222 enables an athlete to interact via gestures and/or audio commands in order to access feedback mechanism 110. In such an embodiment, sensor array 220 may include an acoustic microphone close to user's mouth such as in the frame of the glasses.

In a further embodiment, sensor array 220 may include other types of sensing components, such as context-aware sensors (e.g., myoelectric sensors, temperature sensors, facial expression and feature measurement sensors working with one or more cameras, environment sensors (such as to sense background colors, lights, etc.), biometric sensors (such as to detect fingerprints, facial points or features, etc.), and the like. According to one embodiment, sensors in sensor array 220 may be included in multiple wearable devices and transmit data (raw or analyzed) data to athletic feedback mechanism 110.

Communication logic 225 may be used to facilitate dynamic communication and compatibility between with various other computing devices (such as a mobile computing device, a desktop computer, a server computing device, etc.), storage devices, databases and/or data sources, such as database 240, networks (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), connectivity and location management techniques, software applications/websites), programming languages, etc., while ensuring compatibility with changing technologies, parameters, protocols, standards, etc.

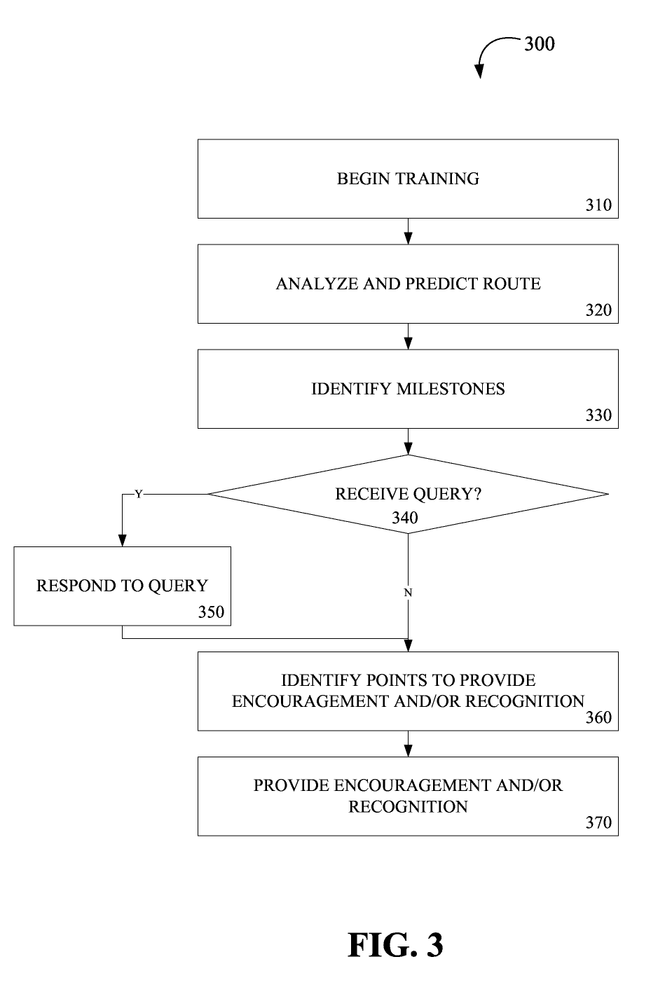

FIG. 3 is a flow diagram illustrating one embodiment of a process 300 performed by an athletic feedback mechanism. Process 300 may be performed by processing logic that may comprise hardware (e.g., circuitry, dedicated logic, programmable logic, etc.), software (such as instructions run on a processing device), or a combination thereof. In one embodiment, method 300 may be performed by athletic feedback mechanism 110. The processes of method 300 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1 and 2 may not be discussed or repeated here.

At processing block 310, the athlete begins a workout (e.g., a cyclist starts to ride). In one embodiment, the workout implements a new route, an explicitly selected route, or a route that the athlete has taken before. At processing block 320, predictive analysis module 201 analyzes and predicts the route the athlete will take based on information such as the route the athlete has selected, the route athlete is currently on, routes athlete has taken before, and cycling routes taken by other athletes. At processing block 330, predictive analysis module 201 identifies key milestones.

In one embodiment, the key milestones include top of slopes, top of the mountain and steep climbs or downhill In a further embodiment, predictive analysis module 201 may analyze terrain information over a predetermine distance ahead (e.g., 100 miles), or a typical largest distance an athlete may perform (e.g., cyclist may ride) on one day. This distance is adaptive since predictive analysis module 201 knows more about the typical distance the athlete may perform. Predictive analysis module 201 may also calculate the effort needed to reach the milestones, including the vertical distance, route distance and gradient changes. In one embodiment, the significance of the milestones may be analyzed based on information such as elevation gain to reach the milestones, and number of people who have reached the milestones.

As discussed above, machine learning logic 205 is implemented to perform unsupervised learning to reinforce positive outcomes with raw data. At decision block 340, a determination is made as to whether a user query has been received. In one embodiment, the athlete may ask various questions related to the terrain and route, such as “how much more climb to the top of the mountain?” “what is the distance to the top?” “what is the steepest grade to the top?” “how many slopes to the top of the mountain?” “Is this top of the hill?”. If a user query has been received, user queries module 207 responds to the query by answering the questions, processing block 350. Answers provided by queries module 207 enables athletes to be well prepared for what is ahead on a ride, and feel satisfied about the accomplishment. In a further embodiment, intelligent UI module 209 may send queries on the user's behalf at appropriate points to enable automatic feedback to be provided by feedback module 203. For example, intelligent UI module 209 may query and update the user about gradient change and total elevation every 10 minutes when a user is climbing over a slope.

At processing block 360, feedback module 203 analyzes workout context in real time to identify points at which to provide encouragement and/or recognition, processing block 360. At processing block 370, feedback module 203 provides encouragement, recognition and/or feedback when appropriate. Embodiments of scenarios include feedback module 203 providing audio feedback that says “Good job. Half way through this climb. 15 miles remaining to the top of this slope,” when the athlete is half way through a long slope.

Other examples include saying “Great job. You are almost to the top, one more mile remaining,” when the cyclist is one mile to the top; “Hold onto the push, this segment is the steepest,” when the athlete is riding through a very steep climb “Congratulations! You did it! This is the top of the mountain. You are among the 150 people who have reached this point,” when the athlete reaches a top of the mountain that very few people have claimed; and “You did it! You are now the king of the mountain,” when the athlete achieves the best performance among all riders to reach the top of the mountain.

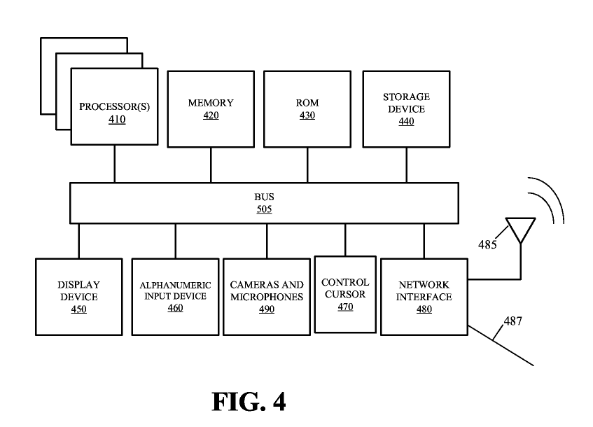

FIG. 4 illustrates a computer system suitable for implementing embodiments of the present disclosure. Computing system 400 includes bus 405 (or, for example, a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable (or computer-readable) media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate athletic feedback comprising a predictive analysis module to identify a route that is to be taken during a user workout and perform predictive analysis of the route and a feedback module to provide real-time feedback to a user based on the predictive analysis.

Example 2 includes the subject matter of Example 1, further comprising machine learning logic to receive feedback data and automatically adapt the workout based on user workout habits indicated in the feedback data.

Example 3 includes the subject matter of Examples 1 and 2, further comprising a user queries module to receive a user query on current and predictive terrain information during the user workout.

Example 4 includes the subject matter of Examples 1-3, further comprising an intelligent user interface module to submit a query on behalf of the user.

Example 5 includes the subject matter of Examples 1-4, wherein the feedback module provides feedback to the user in response to a query.

Example 6 includes the subject matter of Examples 1-5, wherein the predictive analysis module predicts the route based on at least one of a current route, routes previously taken before, social information on routes other athletes have taken and nearby terrain information.

Example 7 includes the subject matter of Examples 1-6, wherein the predictive analysis provides analysis on a type of route the user will take during the workout.

Example 8 includes the subject matter of Examples 1-7, wherein the predictive analysis module provides an analysis on a terrain to identify milestones along the predicted route.

Example 9 includes the subject matter of Examples 1-8, wherein the predictive provides an analysis an effort needed to reach the milestones.

Example 10 includes the subject matter of Examples 1-9, wherein the predictive analysis module identifies points on the route at which the user may need encouragement or acknowledgement.

Example 11 includes the subject matter of Examples 1-10, wherein the feedback module provides audio feedback.

Some embodiments pertain to Example 12 that includes a method to facilitate athletic feedback comprising identifying a route that is to be taken during a user workout, performing predictive analysis of the route and providing real-time feedback to a user during the workout based on the predictive analysis.

Example 13 includes the subject matter of Example 12, further comprising receiving feedback data and automatically adapt the workout based on user workout habits indicated in the feedback data.

Example 14 includes the subject matter of Examples 12 and 13, further comprising receiving a user query regarding current and predictive terrain information during the user workout.

Example 15 includes the subject matter of Examples 12-14, further comprising receiving an intelligent query on behalf of the user regarding current and predictive terrain information during the user workout.

Example 16 includes the subject matter of Examples 12-15, further comprising responding to a query.

Example 17 includes the subject matter of Examples 12-16, further comprising predicting the route based on at least one of a current route, routes previously taken before, social information on routes other athletes have taken and nearby terrain information.

Example 18 includes the subject matter of Examples 12-17, further comprising providing analysis on a type of route the user will take during the workout.

Example 19 includes the subject matter of Examples 12-18, further comprising providing an analysis on a terrain to identify milestones along the predicted route.

Example 20 includes the subject matter of Examples 12-19, further comprising providing an analysis an effort needed to reach the milestones.

Example 21 includes the subject matter of Examples 12-20, further comprising identifying points on the route at which the user may need encouragement or acknowledgement.

Some embodiments pertain to Example 22 that includes at least one computer readable medium having instructions stored thereon, which when executed by a processor, cause the processor to identify a route that is to be taken during a user workout, perform predictive analysis of the route and provide real-time feedback to a user during the workout based on the predictive analysis.

Example 23 includes the subject matter of Example 22, having instructions stored thereon, which when executed by a processor, further cause the processor to receive feedback data and automatically adapt the workout based on user workout habits indicated in the feedback data.

Example 24 includes the subject matter of Examples 22 and 23, having instructions stored thereon, which when executed by a processor, further cause the processor to receive user queries on current and predictive terrain information during the user workout and respond to the query.

Example 25 includes the subject matter of Examples 22-24, having instructions stored thereon, which when executed by a processor, further cause the processor to provide analysis on a type of route the user will take during the workout.

Example 26 includes the subject matter of Examples 22-25, having instructions stored thereon, which when executed by a processor, further cause the processor to provide an analysis on a terrain to identify milestones along the predicted route

Example 27 includes the subject matter of Examples 22-27, having instructions stored thereon, which when executed by a processor, further cause the processor to identify points on the route at which the user may need encouragement or acknowledgement.

Some embodiments pertain to Example 28 that includes an apparatus to facilitate athletic feedback comprising means for identifying a route that is to be taken during a user workout, means for performing predictive analysis of the route and means for providing real-time feedback to a user during based on the predictive analysis.

Example 29 includes the subject matter of Example 28, means for receiving feedback data and means for automatically adapt the workout based on user workout habits indicated in the feedback data.

Example 30 includes the subject matter of Examples 28 and 29, means for receiving user queries on current and predictive terrain information during the user workout and means for respond to the querying.

Example 31 includes the subject matter of Examples 28-30, means for providing analysis on a type of route the user will take during the workout.

Some embodiments pertain to Example 32 that includes at least one computer readable medium having instructions stored thereon, which when executed by a processor, cause the processor to perform the operations of method claims 12-21.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus to facilitate athletic feedback comprising:
a predictive analysis module to identify a route that is to be taken during a user workout and perform predictive analysis of the route; and
a feedback module to provide real-time feedback to a user during the user workout based on the predictive analysis.

2. The apparatus of claim 1, further comprising machine learning logic to receive feedback data and automatically adapt the user workout based on user workout habits indicated in the feedback data.

3. The apparatus of claim 2, further comprising a user queries module to receive a user query on current and predictive terrain information during the user workout.

4. The apparatus of claim 3, further comprising an intelligent user interface module to submit a query on behalf of the user.

5. The apparatus of claim 4, wherein the feedback module provides feedback to the user in response to a query.

6. The apparatus of claim 1, wherein the predictive analysis module predicts the route based on at least one of a current route, routes previously taken before, social information on routes other athletes have taken and nearby terrain information.

7. The apparatus of claim 1, wherein the predictive analysis provides analysis on a type of route the user will take during the user workout.

8. The apparatus of claim 7, wherein the predictive analysis module provides an analysis on a terrain to identify milestones along the predicted route.

9. The apparatus of claim 8, wherein the predictive provides an analysis on effort needed to reach the milestones.

10. The apparatus of claim 7, wherein the predictive analysis module identifies points on the route at which the user may need encouragement or acknowledgement.

11. The apparatus of claim 1, wherein the feedback module provides audio feedback.

12. A method to facilitate athletic feedback comprising:
a predictive analysis module identifying a route that is to be taken during a user workout;
the predictive analysis module performing predictive analysis of the route; and
a feedback module providing real-time feedback to a user based on the predictive analysis.

13. The method of claim 12, further comprising:
the a feedback module receiving feedback data; and
the a feedback module automatically adapting the user workout based on user workout habits indicated in the feedback data.

14. The method of claim 13, further comprising a user queries module receiving a user query regarding current and predictive terrain information during the user workout.

15. The method of claim 14, further comprising the user queries module receiving an intelligent query on behalf of the user regarding current and predictive terrain information during the user workout.

16. The method of claim 15, further comprising responding to a query.

17. The method of claim 12, further comprising the predictive analysis module predicting the route based on at least one of a current route, routes previously taken before, social information on routes other athletes have taken and nearby terrain information.

18. The method of claim 12, further comprising the predictive analysis module providing analysis on a type of route the user will take during the user workout.

19. The method of claim 12, further comprising the predictive analysis module providing an analysis on a terrain to identify milestones along the predicted route.

20. The method of claim 19, further comprising the predictive analysis module providing an analysis an effort needed to reach the milestones.

21. The method of claim 19, further comprising the predictive analysis module identifying points on the route at which the user may need encouragement or acknowledgement.

22. At least one computer readable medium having instructions stored thereon, which when executed by a processor, cause the processor to:
identify a route that is to be taken during a user workout;
perform predictive analysis of the route; and
provide real-time feedback to a user based on the predictive analysis.

23. The at least one computer readable medium of claim 22, having instructions stored thereon, which when executed by a processor, further cause the processor to:
receive feedback data; and
automatically adapt the user workout based on user workout habits indicated in the feedback data.

24. The at least one computer readable medium of claim 23, having instructions stored thereon, which when executed by a processor, further cause the processor to:
receive user queries on current and predictive terrain information during the user workout; and
respond to the query.

25. The at least one computer readable medium of claim 23, having instructions stored thereon, which when executed by a processor, further cause the processor to provide analysis on a type of route the user will take during the user workout.
